(19) United States
(12) Patent Application Publication
(10) Pub. No.: US 2024/0097485 A1
(43) Pub. Date: Mar. 21, 2024

(54) POWER CONTROL DEVICE, POWER CONTROL METHOD, AND NON-TRANSITORY COMPUTER-READABLE RECORDING MEDIUM

(71) Applicant: IHI CORPORATION, Tokyo (JP)

(72) Inventors: Toshinobu ARIMURA, Tokyo (JP); Akinobu INAMURA, Tokyo (JP); Misako KONISHI, Tokyo (JP); Kenichi HAMAGUCHI, Tokyo (JP)

(73) Assignee: IHI CORPORATION, Tokyo (JP)

(21) Appl. No.: 18/232,445

(22) Filed: Aug. 10, 2023

(30) Foreign Application Priority Data
Sep. 15, 2022 (JP) 2022-147175

(51) Int. Cl. H02J 13/00; G06Q 50/06; H02J 3/00

(52) U.S. Cl. CPC H02J 13/00002; G06Q 50/06; H02J 3/003

(57) ABSTRACT

Economic efficiency in power control including transmission and reception of electric power to and from an external power market is improved. An EMS serving as a power control device that is able to transmit and receive electric power to and from a power market and controls operations of one or more power instruments includes: a host control unit serving as a transmitted/received electric power determining unit configured to determine an amount of transmitted/received electric power which is an amount of electric power transmitted to and received from the power market based on a power-market unit price in the power market and information related to an operating situation of the one or more power instruments; and an intra-grid control unit serving as an operation instruction determining unit configured to determine an operation instruction for the one or more power instruments based on the determined amount of transmitted/received electric power.

### CROSS-REFERENCE TO RELATED APPLICATION

This application claims the benefit of priority from Japanese Patent Application No. 2022-147175, filed on Sep. 15, 2022, the entire contents of which are incorporated herein by reference.

### TECHNICAL HELD

The present disclosure relates to a power control device, a power control method, and a power control program.

### BACKGROUND

In the related art, various studies for an energy management control method in an energy community such as a microgrid have been carried out, and a technique of performing control focused on a power price has been studied. For example, Patent Document 1 discloses that a power price pattern which is a pattern of scheduled power prices in a time series after a current time point in a community is used to prepare an operation plan of distributed power supply devices and/or energy storage devices in a consumer group set in the community.

### PATENT DOCUMENT

[Patent Document 1] Japanese Patent No. 3980541

### SUMMARY

However, in the method described in Patent Document 1, since there is a likelihood that transmission and reception of electric power to and from an external power system will be performed based on a power price different from an actual transactional price depending on accuracy of the power price pattern, there is room for improvement in view of economic efficiency.

The present disclosure was invented in consideration of the aforementioned circumstances and an objective thereof is to provide a technique of enabling improvement in economic efficiency in power control including transmission and reception of electric power to and from an external power market.

A power control device according to an aspect of the present disclosure is a power control device that is able to transmit and receive electric power to and from a power market and controls operations of one or more power instruments, the power control device including: a transmitted/received electric power determining unit configured to determine an amount of transmitted/received electric power which is an amount of electric power transmitted to and received from the power market based on a power-market unit price in the power market and information related to an operating situation of the one or more power instruments; and an operation instruction determining unit configured to determine an operation instruction for the one or more power instruments based on the determined amount of transmitted/received electric power.

A power control method according to another aspect of the present disclosure is a power control method of enabling transmission and reception of electric power to and from a power market and controlling operations of one or more power instruments, the power control method including: determining an amount of transmitted/received electric power which is an amount of electric power transmitted to and received from the power market based on a power-market unit price in the power market and information related to an operating situation of the one or more power instruments; and determining an operation instruction for the one or more power instruments based on the determined amount of transmitted/received electric power.

A non-transitory computer-readable recording medium storing, a power control program according to another aspect of the present disclosure is a non-transitory computer-readable recording medium storing a power control program causing a computer to perform enabling transmission and reception of electric power to and from a power market and controlling operations of one or more power instruments, the power control program causing the computer to perform: determining an amount of transmitted/received electric power which is an amount of electric power transmitted to and received from the power market based on a power-market unit price in the power market and in formation related to an operating situation of the one or more power instruments; and determining an operation instruction for the one or more power instruments based on the determined amount of transmitted/received electric power.

With the power control device, the power control method, and the power control program, an amount of transmitted/received electric power Which is transmitted to and received from a power market is determined based on a power-market unit price in the power market and information related to an operating situation of one or more power instruments, and an operation instruction for the one or more power instruments is determined based on the determined amount of transmitted/received electric power. Since the amount of transmitted/received electric power is determined in consideration of the power-market unit price and the operation instruction is determined based on the amount of transmitted/received electric power in this way, it is possible to improve economic efficiency in power control including transmission and reception of electric power to and from an external power market.

The information related to the operating situation of the one or more power instruments may be a predicted demand value obtained by predicting demand for electric power in the one or more power instruments.

With this configuration, since the amount of transmitted/received electric power is determined based on the predicted demand value of electric power and the power-market unit price, it is possible to perform power control using the amount of transmitted/received electric power in consideration of the predicted demand value.

The information related to the operating situation of the one or more power instruments may be a planned demand value related to an electric power demand plan in the one or more power instruments.

With this configuration, since the amount of transmitted/received electric power is determined based on the planned demand value of electric power and the power-market unit price, it is possible to perform power control using the amount of transmitted/received electric power in consideration of the planned demand value.

The transmitted/received electric power determining unit may compare the power-market unit price with a predetermined unit-price set value related to the power-market unit price and determine the amount of transmitted/received electric power based on the result of comparison.

With this configuration, since the amount of transmitted/received electric power can be determined based on the result of comparison between the power-market unit price and the unit-price set value, it is possible to more appropriately perform power control in consideration of economic efficiency such as reducing an amount of purchased electric power, for example, when the power-market unit price is higher than the unit-price set value.

The one or more power instruments may include a power storage device, and the transmitted/received electric power determining unit may determine the amount of transmitted/received electric power additionally based on information related to an amount of electric power charged in the power storage device.

With this configuration, since the amount of transmitted/received electric power can be determined in consideration of the amount of electric power charged in the power storage device, it is possible to more appropriately perform power control in consideration of economic efficiency such as reducing an amount of purchased electric power, for example, when the power-market unit price is higher than the unit-price set value and the amount of electric power charged in the power storage device is sufficiently large.

The power control device may further include an output unit configured to output the operation instruction determined by the operation instruction determining unit to the one or more power instruments.

With this configuration, it is possible to appropriately execute an operation instruction for the one or more power instruments.

According to the present disclosure, it is possible to provide a technique of enabling improvement in economic efficiency in power control including transmission and reception of electric power to and from an external power market.

### BRIEF DESCRIPTION OF THE DRAWINGS

FIG. 1 is a diagram schematically illustrating a microgrid including an EMS serving as a power control device according to an embodiment.

FIG. 2 is a block diagram illustrating functions of the EMS.

FIG. 3 is a block diagram illustrating functions of a host control unit of the EMS.

FIG. 4 is a block diagram illustrating functions of an intra-grid control unit of the EMS.

FIG. 5 is a sequence diagram illustrating a power control method.

FIG. 6 is a diagram illustrating an example of a hardware configuration of the EMS.

### DETAILED DESCRIPTION

Hereinafter, an embodiment of the present disclosure will be described in detail with reference to the accompanying drawings. In description with reference to the drawings, the same elements will be referred to by the same reference signs, and description thereof will not be repeated.

[Microgrid]

A power control device, a power control method, and a power control program according to an embodiment are used for a microgrid.

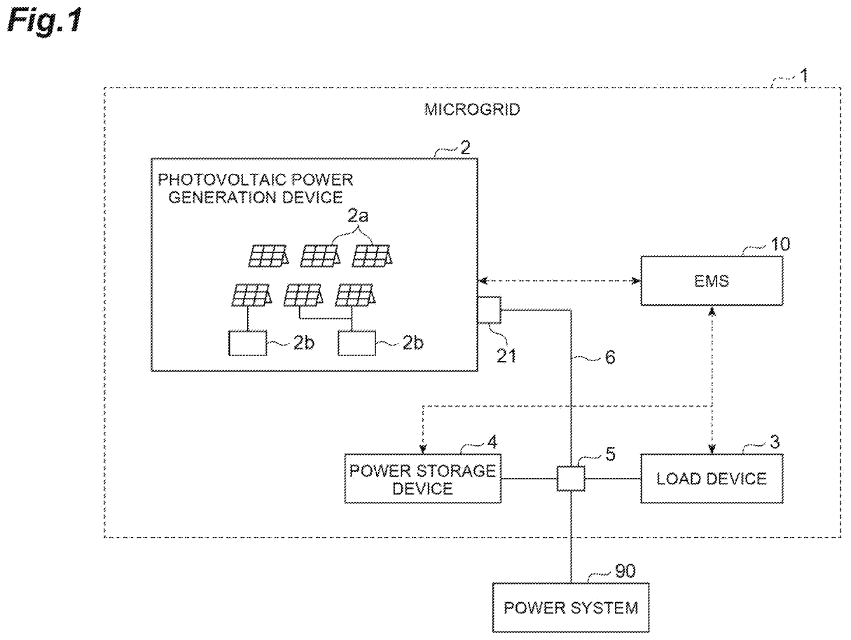

A microgrid will be described below with reference to FIG. 1. FIG. 1 is a diagram schematically illustrating a configuration of a microgrid according to an embodiment. The microgrid 1 includes a power generation facility 2, a load device 3, a power storage device 4, a power distribution device (a switchboard device) 5, a power transmission network 6 connecting these constituents, and an energy management system (EMS) 10 controlling these constituents. In the microgrid 1, generated electric power output from the power generation facility 2 is consumed by the load device 3. In FIG. 1, the power generation facility 2, the load device 3, and the power storage device 4 are illustrated alone, but the numbers of devices may be appropriately changed.

The microgrid 1 operates ideally such that electric power generated by the power generation facility 2 and load electric power consumed by the load device 3 are the same. Accordingly, the EMS 10 adjusts the generated electric power and the load electric power. The EMS 10 may adjust charging/discharging of a storage battery in the power storage device 4 serving as a buffer between the generated electric power and the load electric power. The microgrid 1 is connected to a power system 90. Accordingly, a shortage in electric power can be purchased from the power system 90, and surplus electric power can be sold from the microgrid 1 to the power system 90. The EMS 10 also performs control associated with transmission and reception of electric power to and from the power system 90. In this embodiment, the external power system 90 is a system that can transmit and receive electric power based on transaction results in a power market in which transactions (purchases and sales) of electric power between a plurality of power sellers and a plurality of power buyers are performed. That is, since electric power which is transmitted to and received from the power system 90 is based on transactions in the power market, the EMS 10 can participate in transactions of electric power in the power market. The microgrid 1 may indirectly transmit and receive electric power to and from the power market via a resource aggregator or a balancing group which is not illustrated.

An operation mode of the microgrid 1 may flexibly change. The microgrid 1 may get all required electric power from the power generation facility 2 or may get some of the required electric power from the power system 90. In the microgrid 1, all the electric power generated therein may be consumed by the load device 3.

The power generation facility 2 is a facility that generates electric power using renewable energy. In this embodiment, the power generation facility 2 is a photovoltaic (PV) power generation device and includes a plurality of photovoltaic panels 2a and a plurality of power conditioning systems (PCSs) 2b. The power generation facility 2 may include, for example, the photovoltaic power generation device, or may include a power generation device using another type of renewable energy. For example, two PCSs 2b used in the photovoltaic power generation device are illustrated in FIG. 1. Each PCS 2b is a power conversion device that converts electric power generated by the photovoltaic panels 2a. A plurality of PCSs 2b are provided in the power generation facility 2 and can be connected to one or more photovoltaic panels 2a. Each PCS 2b converts DC electric power from the photovoltaic panels 2a to AC electric power and outputs the AC electric power to the power transmission network 6.

The load device 3 is connected to the power generation facility 2, the power storage device 4, and the power system 90 via the power transmission network 6. The load device 3 consumes electric power generated by the power generation facility 2 and electric power supplied from the power system 90 to perform a predetermined operation. The load device 3 may be configured to operate in cooperation with a load device or the like provided outside of the microgrid 1.

The power storage device 4 stores energy accompanying electric power generated by the power generation facility 2. In this embodiment, the power storage device 4 stores electric power generated by the power generation facility 2. For example, the power storage device 4 outputs (discharges) a predetermined amount of output electric power to the load device 3. The microgrid 1 may include a device that stores or supplies electric power generated by the power generation facility 2 by manufacturing energy carriers (for example, hydrogen or ammonia) other than electricity instead of the power storage device 4.

For example, the power distribution device 5 is connected to the power generation facility 2, the load device 3, the power storage device 4, and the power system 90 and outputs predetermined electric power in which electric power generated by the power generation facility 2, electric power output from the power storage device 4, and electric power supplied from the power system 90 are combined to the load device 3 under the control of the EMS 10. For example, the power distribution device 5 outputs a predetermined amount of electric power output from the power storage device 4 and a part of electric power generated by the power generation facility 2 to the load device 3. The part of the generated electric power output from the power distribution device 5 to the load device 3 is electric power corresponding to a shortage of the electric power output from the power storage device 4 on the load electric power. When the generated electric power from the power generation facility 2 and the electric power output from the power storage device 4 do not cover the load electric power, the power distribution device 5 may supplement the shortage with the supplied electric power bought from the power system 90. The power distribution device 5 may always output the electric power supplied from the power system 90 to the load device 3. The operation of the power distribution device 5 associated with distribution of electric power is performed under the control of the EMS 10 as described above.

In the following, embodiment, the power generation facility 2, the load device 3, the power storage device 4, and the power distribution device 5 which can be involved in power management in the microgrid may be collectively referred to as power instruments.

[EMS]

The EMS 10 manages electric power generated by the power generation facility 2, load electric power in the load device 3, electric power output from the power storage device 4, and electric power which is transmitted and received (bought and sold) to and from the power system 90. In the following embodiment, a case in which the EMS 10 purchases electric power corresponding to a shortage in the microgrid from the power system 90 will be mainly described.

As described above, a power surplus or a power shortage on an amount of electric power used in the microgrid 1 may be implemented by transmission and reception of electric power to and from the power system 90. A unit price of electric power (a power-market unit price) when electric power is purchased from the power system 90 is determined through preliminary tenders of sellers and buyers and is published to the sellers and the buyers. Since the microgrid 1 (the EMS 10) described in this embodiment is also a seller or a buyer as described above, the microgrid 1 also participates in tenders in consideration of demand for electric power in the grid. The EMS 10 performs transmission and reception (selling and buying) of electric power to and from the power system 90 based on the published power-market unit price. The power-market unit price is set for each segment when one day is divided into 48 segments (every 30 minutes). The market price for each segment is published to the public by a power exchange or the like in one day before the segment.

Transactions of electric power between the microgrid 1 and the power system 90 can be performed regardless of an amount of electric power in the preliminary tender. When the determined power-market unit price is different from an expected price, a transaction is performed to resolve the difference (an imbalance) therebetween. For example, when the determined power-market unit price is higher than an electric-power unit price corresponding to the amount of electric power in the tender, payment of the difference (an imbalance charge) is caused and unexpected costs increase due to purchase of an expected amount or electric power. Therefore, the EMS 10 has a function of adjusting an amount of electric power which the microgrid 1 trades with the power system 90 based on the determined power-market unit price. For example, when the power storage device 4 in the microgrid 1 stores a sufficient amount of electric power, a measure of getting electric power consumed in the microgrid 1 by decreasing an amount of electric power bought from the power system 90 and increasing an amount of electric power discharged from the power storage device 4 is considered. On the other hand, when a selling price of electric power to the power market is low, a measure of performing control such that electric power generated by the power generation facility 2 is temporarily stored in the power storage device 4 is considered. That is, when a selling price of electric power to the power market is low, it is considered to perform control such that a timing of supply (selling) of electric power to the power system 90 is adjusted. In this way, the EMS 10 has a function of adjusting an amount of electric power transmitted to and received from the power system 90 in consideration of the power-market unit price, situations of the devices in the microgrid 1, and the like.

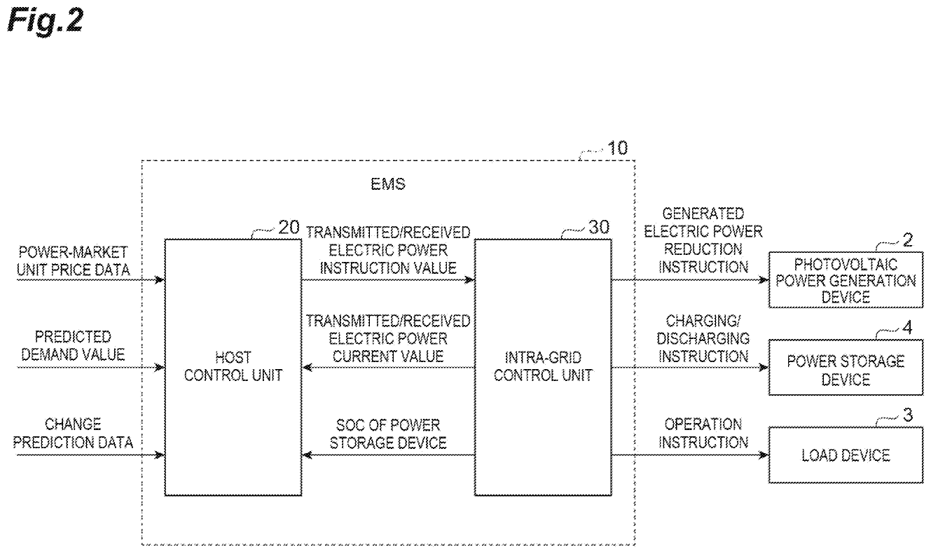

FIG. 2 is a diagram illustrating a functional configuration of the EMS 10. The EMS 10 controls the power generation facility 2, the load device 3, and the power storage device 4. As illustrated in FIG. 2, the EMS 10 includes a host control unit 20 and an intra-grid control unit 30 as functional units. These functional units may be incorporated into one computer or may be distributed to a plurality of computers. The computers may be located in a cloud environment or outside of the microgrid.

The host control unit 20 has a function of a transmitted/received electric power determining unit configured to determine an amount of transmitted/received electric power which is an amount of electric power transmitted to and received from a power market based on a power-market unit price in the power market and information related to operating situations of one or more power instruments, More specifically, the host control unit 20 determines an amount of transmitted/received electric power between the microgrid 1 and the power system 90 based on a power-market unit price when electric power is transmitted to and received from the power system 90 and a predicted demand value of electric power calculated based on operation information of power instruments in the microgrid 1. In addition to the power-market unit price and the predicted demand value, information related to a current demand value of electric power provided from the intra-grid control unit 30, information (state of charge (SOC)) associated with an amount of electric power stored in the power storage device 4, prediction data associated with fluctuation of demand of electric power provided from the outside, and the like can be used to determine the amount of transmitted/received electric power. The function of the host control unit 20 and details of processes performed by the host control unit 20 will be described later.

The intra-grid control unit 30 has a function of an operation instruction determining unit configured to determine an operation instruction for one or more power instruments based on the amount of transmitted/received electric power determined by the host control unit 20. Specifically, the intra-grid control unit 30 has a function of determining control details of the power generation facility 2, the load device 3, and the power storage device 4 in. the microgrid 1 based on the amount of electric power transmitted to and received from the power system 90 which is determined by the host control unit 20. The intra-grid control unit 30 also has a function of an output unit configured to output the operation instruction determined by the operation instruction determining unit to the one or more power instruments. An example of the operation instruction for the power generation facility 2 is a generated electric power reduction instruction. An instruction associated with operation start/stop or increase/decrease of a load can be output to the load device 3, and a charging/discharging instruction can be output to the power storage device 4. Here, the load device 3 can also include a device other than a control target of the EMS 10. Accordingly, an operation instruction is output to only the load device 3 which can be controlled by the EMS 10. The intra-grid control unit 30 notifies the host control unit 20 of an electric power current value which is being transmitted to and received from the power system 90 and information (SOC) associated with the amount of electric power stored in the power storage device 4.

When a rule of transmission and reception of electric power between the microgrid 1 and the external power system 90 is determined, the intra-grid control unit 30 determines control details of the constituent devices in consideration of the rule. For example, when transmission of electric power (an inverse power flow) from the microgrid 1 to the power system 90 is inhibited, control details of the constituent units are determined such that the inverse power flow is not generated. The function of the intra-grid control unit 30 and details of processes performed by the intra-grid control unit 30 will be described later.

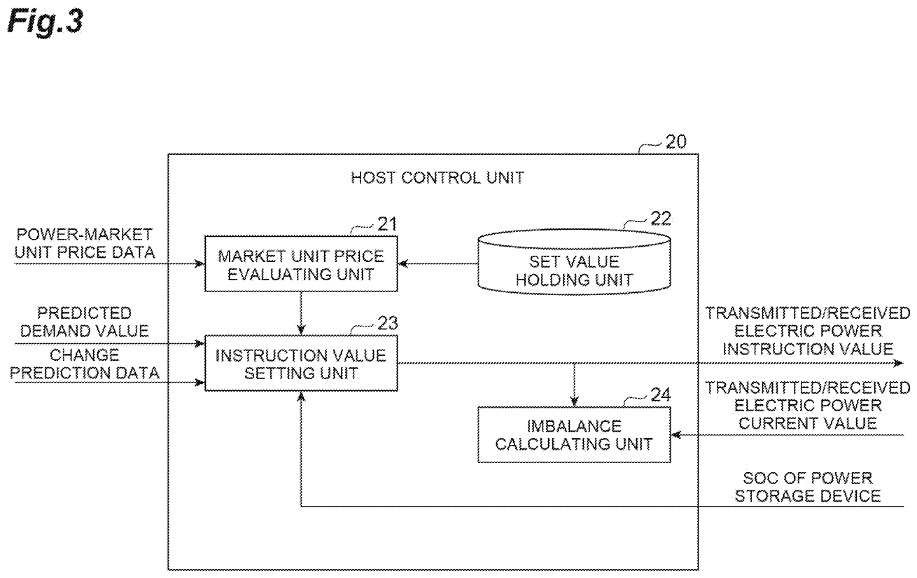

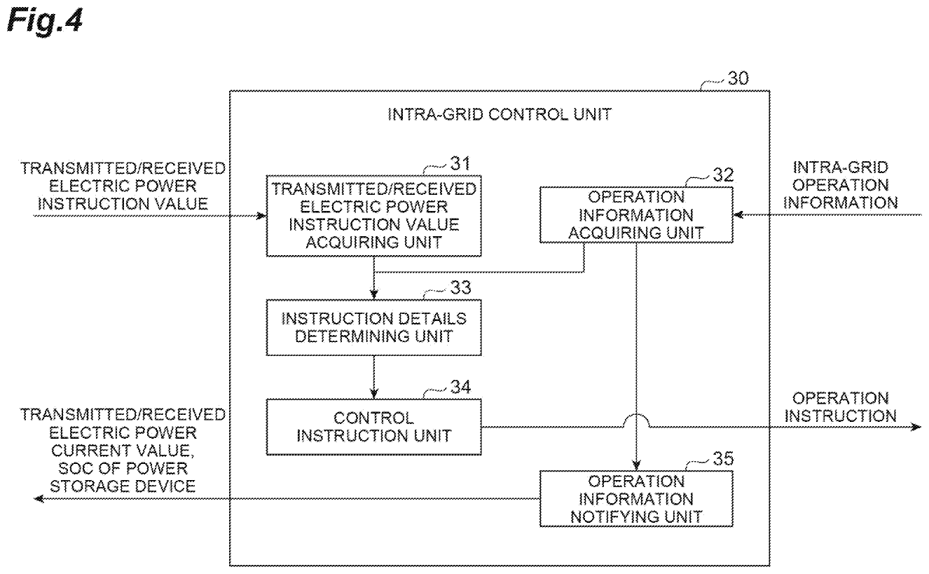

The functions of the constituent units of the host control unit 20 and the intra-grid control unit 30 will be described below with reference to FIGS. 3 and 4.

FIG. 3 is a diagram illustrating the functions of the host control unit 20. As illustrated in FIG. 3, the host control unit 20 includes a market unit price evaluating unit 21, a set value holding unit 22, an instruction value setting unit 23, and an imbalance calculating unit 24.

The market unit price evaluating unit 21 has a function of acquiring power-market unit price data and evaluating a relationship between a market unit price and an expected price. The set value holding unit 22 has a function of holding a set value which is information serving as a reference when the market unit price evaluating unit 21 evaluates the market unit price.

Since data (power-market unit price data) associated with a power-market unit price which is to be evaluated by the market unit price evaluating unit 21 is published to the public from a power exchange or the like that manages selling and buying of electric power in the power system 90 as described above, the market unit price evaluating unit 21 acquires power-market unit price data published to the public. Then, the market unit price evaluating unit 21 evaluates whether the power-market unit price in a target time period indicated by the acquired power-market unit price data is higher or lower than a predetermined set value. Information serving as a reference at that time is held by the set value holding unit 22. The set value is a value which is set for each segment and may be set based on an average value for each segment of the past power-market unit prices or the like. The set value may be set by manual input from a user or may be automatically input from the past power-market unit price data or the like. The set value can be changed depending on seasons, change in power supply situation, or the like. For example, when power-market prices are increased together with an increase of crude oil prices, it is considered to adjust the set value to be slightly higher. In time periods in which an amount of photovoltaic power increases such as the spring and the summer, an electric-power unit price in the daytime is lowered and thus it is conceivable to adjust the set value of the power-market unit price in the daytime to be slightly lower. In this way, the set value of the power-market unit price can be set in consideration of various situations associated with supply of electric power.

The market unit price evaluating unit 21 evaluates by what amount the power-market unit price included in the power-market unit price data is higher/lower than the set value and acquires a result thereof for each segment. For example, the evaluation result may be expressed as a numerical value of a result of calculation of a difference from the set value or may be expressed at levels (for example, evaluation at 5 levels of A to E) based on the difference from the set value. The evaluation result is sent from the market unit price evaluating unit 21 to the instruction value setting unit 23.

The instruction value setting unit 23 has a function of determining an instruction value of an amount of electric power transmitted to and received from the power system 90 in response to a predicted demand value based on the evaluation result from the market unit price evaluating unit 21.

The predicted demand value represents a predicted value of an amount of electric power transmitted to and received from the power system 90, which is calculated based on an amount of generated electric power or an amount of consumed electric power for each device in the microgrid 1. The predicted demand value may be prepared by pattern matching using past result values of electric power demand or the like. The predicted demand value may be prepared by the EMS 10 or data prepared by another device may be used. The predicted demand value may be prepared by manual input from a user or the like.

The instruction value setting unit 23 corrects an amount of electric power which is actually transmitted to and received from the power system 90 based on the predicted demand value using the evaluation result from the market unit price evaluating unit 21. For example, when the market unit price evaluating unit 21 provides an evaluation result indicating that the power-market unit price is higher than the set value, it is assumed that a predicted value indicating that a predetermined amount of electric power is to be purchased from the power system 90 is acquired as the predicted demand value. When the evaluation result from the market unit price evaluating unit 21 is not used, the instruction value is set such that electric power is purchased from the power system 90 based on the predicted demand value. On the other hand, in this embodiment, an instruction value which has been corrected by the instruction value setting unit 23 such that the amount of electric power purchased from the power system 90 decreases is set in consideration of that the power-market unit price is higher than the set value. In this way, the instruction value setting unit 23 does not set the instruction value to be equal to the predicted demand value, but adjusts the amount of electric power purchased from the power system 90 in consideration of the evaluation result of the power-market unit price. The method of adjustment may be determined in advance by the instruction value setting unit 23. A specific example of the method of adjustment is a method or determining an amount of electric power to be adjusted (an amount of electric power of which purchase is waited for) according to the difference between the power-market unit price and the set value or a method of determining an amount of electric power adjusted according to the level of the evaluation result from the instruction value selling unit 23, but the method is not limited thereto.

The SOC of the power storage device 4 in the microgrid 1 is also considered in adjusting the amount of electric power transmitted to and received from the power system 90. For example, when the amount of electric power to be purchased is decreased with respect to the predicted demand value, there is a likelihood that an amount of electric power available in the microgrid 1 will be less than an amount of demand. In this case, a risk of electric power shortage is avoided by using electric power stored in the power storage device 4 in the microgrid 1. That is, by how much the amount of transmitted/received electric power is to be adjusted can also depend on the amount of electric power stored in the power storage device 4. Accordingly, the instruction value setting unit 23 adjusts the instruction value using information related to the SOC in the power storage device 4 which is provided from the intra-grid control unit 30 together.

The instruction value setting unit 23 may adjust the instruction value using change prediction data which is data indicating by how much the demand of electric power in the microgrid 1 changes actually together with respect to the predicted demand value. The change prediction data is, for example, prediction data of factors with a likelihood of affecting the demand of electric power in the microgrid 1 such as solar radiation prediction data or wind speed prediction data. When the change prediction data can be acquired, the instruction value setting unit 23 may adjust the set value using the change prediction data together. The instruction value for the amount of transmitted/received electric power set by the instruction value setting unit 23 is sent to the intra-grid control unit 30.

The imbalance calculating unit 24 calculates an imbalance value based on the transmitted/received electric power instruction value set by the instruction value setting unit 23 and calculates an imbalance charge according to necessity. The imbalance charge is a charge which is generated when an actual amount of transmitted/received electric power departs from the amount of transmitted/received electric power in a preliminary tender. The imbalance charge is caused when the actual amount of transmitted/received electric power is short for an amount of transmitted/received electric power in the preliminary tender (when the actual amount of transmitted/received electric power is larger than the amount of transmitted/received electric power in the preliminary tender) and when the actual amount of transmitted/received electric power is surplus for an amount of transmitted/received electric power in the preliminary tender (when the actual amount of transmitted/received electric power is smaller than the amount of transmitted/received electric power in the preliminary tender). Since unit price information required for calculating the imbalance charge is published later, the unit price information is not confirmed at the timing of purchase. Here, a temporary imbalance charge (a predicted value of the imbalance charge) can be calculated in real time by using a preliminary value, a predicted value, a past average value, or the like for unit information of the imbalance charge. The imbalance calculating unit 24 has a function of calculating an imbalance value based on the transmitted/received electric power instruction value set by the instruction value setting unit 23 and the actual amount of transmitted/received electric power (the current value) and calculating the imbalance charge. Information related to the imbalance value and the imbalance charge calculated by the imbalance calculating unit 24 can be used, for example, for the EMS 10 to evaluate control of transmission/reception of electric power in the microgrid 1.

In the EMS 10 according to this embodiment, there is a likelihood that imbalance will occur by transmitting or receiving an amount of electric power different from the amount of transmitted/received electric power in the preliminary tender as described above. Particularly, when the power-market unit price is higher than the set value, it is assumed to perform control such that the actual amount of transmitted/received electric power is less than the amount of transmitted/received electric power in the preliminary tender. In this case, the difference between the amount of transmitted/received electric power in the preliminary tender and the actual amount of transmitted/received electric power is a power surplus, and electric power is sold to the power market at a lower price in comparison with a case in which electric power is supplied from the marketer. A loss due to a decrease of the selling price is less than a loss due to the imbalance charge occurring when the actual amount of transmitted/received electric power is larger than the amount of transmitted/received electric power in the preliminary tender. Accordingly, the EMS 10 does not consider the loss when the actual amount of transmitted/received electric power is smaller than the amount of transmitted/received electric power in the preliminary tender in consideration of the power-market unit price. Here, the instruction value setting unit 23 may be configured to calculate the amount of transmitted/received electric power in consideration of the loss which is predicted when the actual amount of transmitted/received electric power is smaller than the amount of transmitted/received electric power in the preliminary tender.

FIG. 4 is a diagram illustrating the function of the intra grid control unit 30. As illustrated in FIG. 4, the intra-grid control unit 30 includes a transmitted/received electric power instruction value acquiring unit 31, an operation information acquiring unit 32, an instruction details determining unit 33, a control instruction unit 34, and an operation information notifying unit 35.

The transmitted/received electric power instruction value acquiring unit 31 has a function of acquiring a transmitted/received electric power instruction value from the host control unit 20. The acquired transmitted/received electric power instruction value is sent to the instruction details determining unit 33.

The operation information acquiring unit 32 has a function of acquiring operation information from the constituent devices in the microgrid 1. Examples of the operation information include information related to an amount of electric power generated by the power generation facility 2, information related to an amount of electric power consumed in the load device 3, and a current value of an amount of electric power transmitted to and received from the power system 90 which is the information (SOC) associated with the amount of electric power stored in the power storage device 4. The operation information is sent to the instruction details determining unit 33. Among this information, the current value of the amount of transmitted/received electric power and the SOC of the power storage device 4 are also sent to the operation information notifying unit 35.

The instruction details determining unit 33 has a function of determining instruction details for the constituent devices in the microgrid 1 based on the transmitted/received electric power instruction value acquired from the transmitted/received electric power instruction value acquiring unit 31 and the operation information acquired from the operation information acquiring unit 32. An amount of electric power to be transmitted to and received from the power system 90 is confirmed based on the transmitted/received electric power instruction value from the transmitted/received electric power instruction value acquiring unit 31. On the other hand, current operating situations of the devices in the microgrid 1 can be ascertained based on the operation information from the operation information acquiring unit 32. Therefore, the instruction details determining unit 33 determines operation details of the devices such that electric power can be smoothly supplied to the devices under the condition that the amount of electric power to be transmitted to and received from the power system 90 is set to a predetermined value. Examples of the operation details determined at that time include adjustment of the amount of electric power discharged from the power storage device 4, adjustment of the amount of electric power generated in the power generation facility 2, and adjustment of the load in the load device 3. Information related to the operation instructions for the devices in the load based on the instruction details determined by the instruction details determining unit 33 is sent from the instruction details determining unit 33 to the control instruction unit 34.

The control instruction unit 34 has a function of transmitting the operation instructions to the devices in the microgrid 1. That is, the control instruction unit 34 serves as an output unit configured to output an operation instruction to one or more power instruments.

The operation information notifying unit 35 has a function of transmitting and receiving the current value of the amount of transmitted/received electric power and the SOC of the power storage device 4 sent from the operation information acquiring unit 32 to/from the host control unit 20.

[Power Control Method]

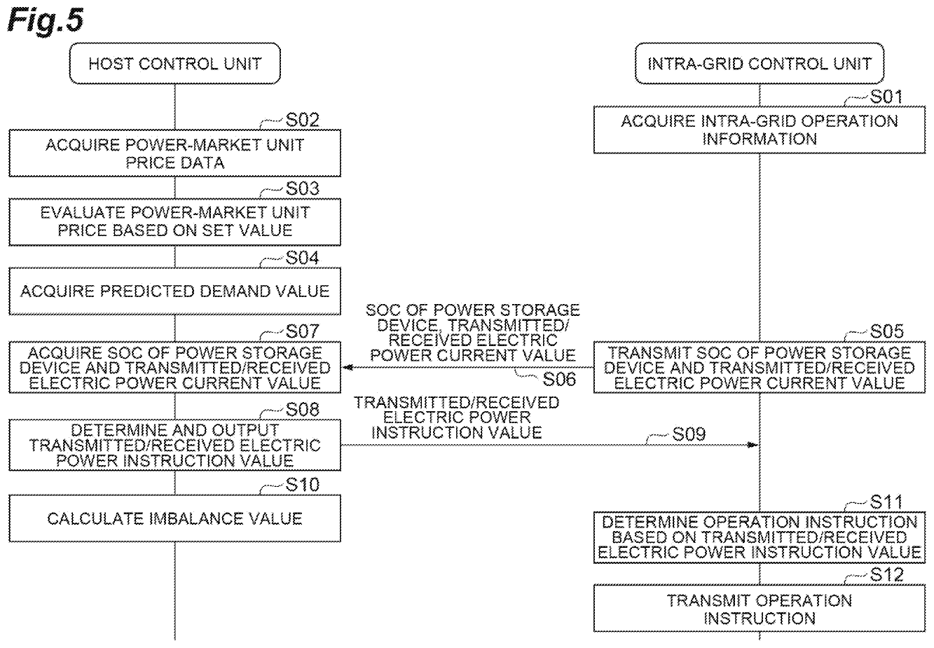

Operations associated with electric power control which are performed by the host control unit 20 and the intra-grid control unit 30 of the EMS 10 will be described below with reference to FIG. 5.

First, in the intra-grid control unit 30, the operation information acquiring unit 32 acquires operation information of the devices in the microgrid 1 (Step S01). Acquisition of the operation information by the operation information acquiring unit 32 is performed, for example, at predetermined timings (for example, every minute or every segment). The acquired information is sent as intra-grid operation information from the operation information acquiring unit 32 to the instruction details determining unit 33.

On the other hand, in the host control unit 20, the market unit price evaluating unit 21 acquires power-market unit price data (Step S02). Then, the market unit price evaluating unit 21 evaluates the power-market unit price for calculating the transmitted/received electric power instruction value from the predicted demand value based on the acquired power-market unit price data and the set value held by the set value holding unit 22 (Step S03). At this time, the market unit price evaluating unit 21 may determine correction details of the market unit price of the predicted demand value for calculating the transmitted/received electric power instruction value.

Then, in the host control unit 20, the instruction value setting unit 23 acquires the predicted demand value (Step S04). On the other hand, the operation information notifying unit 35 of the intra-grid control unit 30 sends the SOC of the power storage device 4 and the current value of the amount of transmitted/received electric power from the intra-grid control unit 30 to the host control unit 20 (Steps S05 and S06). In the host control unit 20, the instruction value setting unit 23 and the imbalance calculating unit 24 acquire such information (Step S07).

Then, the instruction value setting unit 23 of the host control unit 20 determines the transmitted/received electric power instruction value and sends the transmitted/received electric power instruction value from the host control unit 20 to the intra-grid control unit 30 (Steps S08 and S09). Thereafter, the imbalance calculating unit 24 of the host control unit 20 calculates an imbalance value based on the transmitted/received electric power instruction value (Step S10). The imbalance calculating unit 24 may calculate an imbalance charge based on the imbalance value.

On the other hand, the transmitted/received electric power instruction value acquiring unit 31 of the intra-grid control unit 30 acquires the transmitted/received electric power instruction value, and then the instruction details determining unit 33 determines instruction details of an operation instruction based on the transmitted/received electric power instruction value (Step S11). Then, the operation instruction based on the instruction details determined by the instruction details determining unit 33 is output from the control instruction unit 34 to the devices (power instruments) in the microgrid 1 (Step S12). Thereafter, the devices operate based on the control instruction.

This routine of processes based on the power-market unit price may be performed, for example, every segment (every 30 minutes) which is a unit time for setting the power-market unit price. Step S01, Steps S02 to S03, Step S04, and Steps S08 to S07 are operations which are independently performed without cooperation. Accordingly, the order of processes may be changed.

[Hardware Configuration]

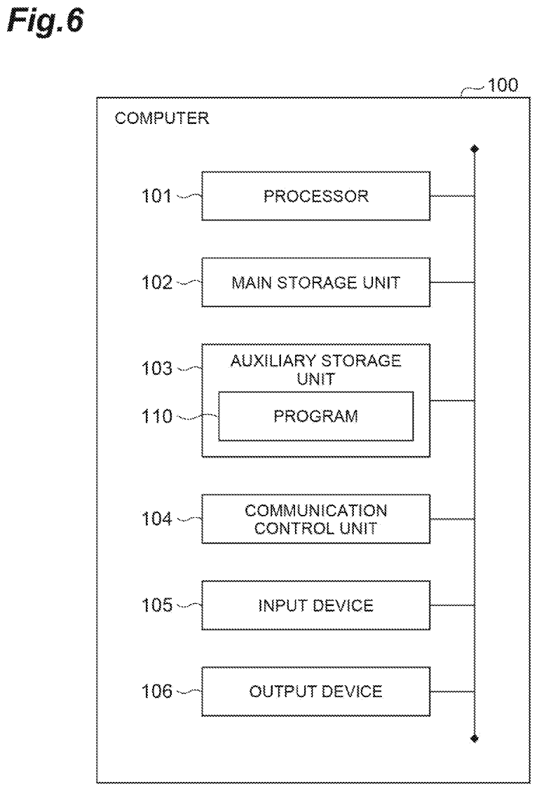

A hardware configuration of the EMS 10 will be described below with reference to Fla 6. FIG. 6 is a diagram illustrating an example of the hardware configuration of the EMS 10. The EMS 10 includes one or more computers 100. Each computer 100 includes a central processing unit (CPU) 101, a main storage unit 102, an auxiliary storage unit 103, a communication control unit 104, an input device 105, and an output device 106. The EMS 10 is constituted by one or more computers 100 including such hardware and software such as programs.

When the EMS 10 is constituted by a plurality of computers 100, the computers 100 may be locally connected or may be connected via a communication network such as the Internet or an intranet. The EMS 10 which is logically single is constructed by such connection.

The CPU 101 executes an operating system, an application program, or the like. The main storage unit 102 includes a read only memory (ROM) and a random access memory (RAM). The auxiliary storage unit 103 is a storage medium including a hard disk and a flash memory. The auxiliary storage unit 103 stores a larger amount of data than the main storage unit 102 in general. The communication control unit 104 is constituted by a network card or a radio communication module. At least a part of the communication function with another device in the EMS 10 may be realized by the communication control unit 104. The input device 105 includes a keyboard, a mouse, a touch and a speech-input microphone. The output device 106 includes a display and a printer.

The auxiliary storage unit 103 stores a program 110 and data required for processing in advance. The program 110 causes the computer 100 to perform the functional units of the EMS 10. In accordance with the program 110, for example, processes associated with the power control method are performed by the computer 100. For example, the program 110 is read by the CPU 101 or the main storage unit 102 to operate at least one of the CPU 101, the main storage unit 102, the auxiliary storage unit 103, the communication control unit 104, the input device 105, and the output device 106. For example, the program 110 performs reading and writing of data from and to the main storage unit 102 and the auxiliary storage unit 103.

For example, the program 110 may be stored in a material recording medium such as a CD-ROM, a DVD-ROM, or a semiconductor memory and then provided. The program 110 may be provided as data signals via a communication network.

A power control program according to this embodiment is a power control program causing a computer 100 to perform enabling transmission and reception of electric power to and from a power market and controlling operations of one or more power instruments. Specifically, for example, the power control program causes the computer 100 to perform: determining an amount of transmitted/received electric power which is an amount of electric power transmitted to and received from the power market based on a power-market unit price in the power market and information related to an operating situation of the one or more power instruments; and determining an operation instruction for the one or more power instruments based on the determined amount of transmitted/received electric power.

[Operations and Advantages of Embodiment]

With the EMS 10 serving as the power control device, the power control method, and the power control program, the host control unit 20 serving as a transmitted/received electric power determining unit determines an amount of transmitted/received electric power which is transmitted to and received from a power market based on a power-market unit price in the power market and information related to an operating situation of one or more power instruments. The intra-grid control unit 30 serving as an operation instruction determining unit determines an operation instruction for the one or more power instruments based on the amount of transmitted/received electric power. Since the amount of transmitted/received electric power is determined in consideration of the power-market unit price and the operation instruction is determined based on the amount of transmitted/received electric power in this way, it is possible to improve economic efficiency in power control including transmission and reception of electric power to and from an external power market.

Electric power control has been performed in the related art while electric power is transmitted to and received from the power market. In the related art, electric power control in consideration of an actual unit price in the power market has not been performed. Accordingly, even when an electric power unit price is high as a result of tenders, transactions as tendered are generally performed. In this case, unexpected costs are likely to increase for getting electric power, and thus there is room for improvement in economic efficiency. On the other hand, with the power control techniques using the EMS 10 according to this embodiment, the amount of transmitted/received electric power is determined based on the power-market unit price as well as the operating situations of one or more power instruments in the load. Accordingly, since the amount of transmitted/received electric power can be adjusted in consideration of change of the power-market unit price, it is possible to realize electric power control with improved economic efficiency.

The information related to the operating situation of power instruments may be, for example, a predicted demand value obtained by predicting demand for electric power in the one or more power instruments. In this case, since the amount of transmitted/received electric power is determined based on the predicted demand value of electric power and the power-market unit price, it is possible to perform electric power control using the amount of transmitted/received electric power in consideration of the predicted demand value.

On the other hand, the information related to the operating situation of the power instruments may be a planned demand value related to an electric power demand plan in the one or more power instruments. The planned demand value mentioned herein means that power consumption is performed as planned. For example, when a power instrument is a manufacturing facility such as a factory, an amount of electric power which can be consumed in the manufacturing facility can be estimated from a production plan, and thus the estimated amount of electric power is the planned demand value. In this case, since the amount of transmitted/received electric power is determined based on the planned demand value of electric power and the power-market unit price, it is possible to perform power control using the amount of transmitted/received electric power in consideration of the planned demand value.

The host control unit 20 of the EMS 10 serving as the transmitted/received electric power determining unit may compare the power-market unit price with a predetermined unit-price set value related to the power-market unit price and determine the amount of transmitted/received electric power based on the result of comparison. In this case, since the amount of transmitted/received electric power can be determined based on the result of comparison between the power-market unit price and the unit-price set value, it is possible to more appropriately perform power control in consideration of economic efficiency such as reducing an amount of purchased electric power, for example, when the power-market unit price is higher than the unit-price set value.

The one or more power instruments may include a power storage device 4. Here, the host control unit 20 serving as the transmitted/received electric power determining unit may determine the amount of transmitted/received electric power additionally based on information related to an amount of electric power charged in the power storage device 4. In this case, since the host control unit 20 can determine the amount of transmitted/received electric power in consideration of the amount of electric power charged in the power storage device 4, it is possible to reduce an amount of purchased electric power, for example, when the power-market unit price is higher than the unit-price set value and the amount of electric power charged in the power storage device is sufficiently large. In this way, the EMS 10 can more appropriately perform electric power control in consideration of economic efficiency by employing this configuration.

The EMS 10 may further include an output unit configured to output the operation instruction determined by the intra-grid control unit 30 serving as the operation instruction determining unit to the one or more power instruments. Specifically, the control instruction unit 34 of the intra-grid control unit 30 may be configured to output the operation instruction to the one or more power instruments. By employing this configuration, it is possible to appropriately execute an operation instruction for one or more power instruments.

### Modified Examples

The present disclosure is not limited to the aforementioned embodiments and can be modified in various forms without departing from the gist thereof.

For example, the configurations of the power instruments in the microgrid 1 described in the aforementioned embodiments can be appropriately modified. The amount of transmitted/received electric power determined by the EMS 10, the method of determining the operation instruction, and the like can be modified according to the configuration of the power instruments.

In the aforementioned embodiments, control is performed such that an amount of electric power to be purchased is reduced when the microgrid 1 purchases electric power from the power system 90 and the power-market unit price is higher than an expected price. However, the method described in the aforementioned embodiments can be applied to a case in which the microgrid 1 sells electric power to the power system 90. For example, it is also possible to control selling of electric power with improved economic efficiency by performing control such that an amount of electric power to be sold is reduced when the power-market unit price is lower than the expected price using the aforementioned method. In this way, the technique described in the aforementioned embodiments can be applied to both buying and selling of electric power from and to the power system 90.

Additional Remark 1

The present disclosure is for solving problems in system operation of a microgrid including unstable generation of renewable energy and contributing to spread of renewable energy. Accordingly, the present disclosure is for contributing to the following targets of the sustainable development goals (SDGs) which are led by the UN.
Target 7.2 “to greatly increase a proportion of renewable energy in the global energy mix until 2030”
Target 9.3 “to improve sustainability by infrastructure improvement or industrial improvement through improvement in resource use efficiency and increasing introduction of clean technology and technical and industrial processes in consideration of an environment and to cause all nations to make effort with capacities thereof until 2030”

Additional Remark 2

The present disclosure includes the following configurations.

[1] A power control device that is able to transmit and receive electric power to and from a power market and controls operations clone or more power instruments, the power control device including:
a transmitted/received electric power determining unit configured to determine an amount of transmitted/received electric power which is an amount of electric power transmitted to and received from the power market based on a power-market unit price in the power market and information related to an operating situation of the one or more power instruments; and
an operation instruction determining unit configured to determine an operation instruction for the one or more power instruments based on the determined amount of transmitted/received electric power.

[2.] The power control device according to [1], wherein the information related to the operating situation of the one or more power instruments is a predicted demand value obtained by predicting demand for electric power in the one or more power instruments.

[3] The power control device according to [1], wherein the information related to the operating situation of the one or more power instruments is a planned demand value related to an electric power demand plan in the one or more power instruments.

[4] The power control device according to [3], wherein the transmitted/received electric power determining unit compares the power-market unit price with a predetermined unit-price set value related to the power-market unit price and determines the amount of transmitted/received electric power based on the result of comparison.

[5] The power control device according to any one of [1] to [4], wherein the one or more power instruments include a power storage device, and
wherein the transmitted/received electric power determining unit determines the amount of transmitted/received electric power additionally based on information related to an amount of electric power charged in the power storage device.

[6] The power control device according to any one of [1] to [5], further including an output unit configured to output the operation instruction determined by the operation instruction determining unit to the one or more power instruments.

[7] A power control method of enabling transmission and reception of electric power to and from a power market and controlling operations of one or more power instruments, the power control method including:
determining an amount of transmitted/received electric power which is an amount of electric power transmitted to and received from the power market based on a power-market unit price in the power market and information related to an operating situation of the one or more power instruments: and
determining an operation instruction for the one or more power instruments based on the determined amount of transmitted/received electric power.

[8] A power control program causing a computer to perform enabling transmission and reception of electric power to and from a power market and controlling operations of one or more power instruments, the power control program causing the computer to perform:
determining an amount of transmitted/received electric power which is an amount of electric power transmitted to and received from the power market based on a power-market unit price in the power market and information related to an operating situation of the one or more power instruments; and
determining an operation instruction for the one or more power instruments based on the determined amount of transmitted/received electric power.

### REFERENCE SIGNS LIST

1 Microgrid
2 Power generation facility
3 Load device
4 Power storage device
5 Power distribution device (switchboard device)
6 Power transmission network
10 EMS (power control device)
20 Host control unit (transmitted/received electric power determining unit)
21 Market unit price evaluating unit
22 Set value holding unit
23 Instruction value setting unit
24 Imbalance calculating unit
30 Intra-grid control unit (operation instruction determining unit)
31 Transmitted received electric power instruction value acquiring unit
32 Operation information acquiring unit
33 Instruction details determining unit
34 Control instruction unit (output unit)
35 Operation information notifying unit
90 Power system

What is claimed is:

1. A power control device that is able to transmit and receive electric power to and from a power market and controls operations of one or more power instruments, the power control device comprising:
a transmitted/received electric power determining unit configured to determine an amount of transmitted/received electric power which is an amount of electric power transmitted to and received from the power market based on a power-market unit price in the power market and information related to an operating situation of the one or more power instruments; and
an operation instruction determining unit configured to determine an operation instruction for the one or more power instruments based on the determined amount of transmitted/received electric power.

2. The power control device according to claim 1, wherein the information related to the operating situation of the one or more power instruments is a predicted demand value obtained by predicting demand for electric power in the one or more power instruments.

3. The power control device according to claim 1, wherein the information related to the operating situation of the one or more power instruments is a planned demand value related to an electric power demand plan in the one or more power instruments.

4. The power control device according to claim 1, wherein the transmitted/received electric power determining unit compares the power-market unit price with a predetermined unit-price set value related to the power-market unit price and determines the amount of transmitted/received electric power based on the result of comparison.

5. The power control device according to claim 1, wherein the one or more power instruments include a power storage device, and
wherein the transmitted/received electric power determining unit determines the amount of transmitted/received electric power additionally based on information related to an amount of electric power charged in the power storage device.

6. The power control device according to claim 1, further comprising an output unit configured to output the operation instruction determined by the operation instruction determining unit to the one or more power instruments.

7. A power control method of enabling transmission and reception of electric power to and from a power market and controlling operations of one or more power instruments, the power control method comprising:
determining an amount of transmitted/received electric power which is an amount of electric power transmitted to and received from the power market based on a power-market unit price in the power market and information related to an operating situation of the one or more power instruments; and
determining an operation instruction for the one or more power instruments based on the determined amount of transmitted/received electric power.

8. A non-transitory computer-readable recording medium storing a power control program causing a computer to perform enabling transmission and reception of electric power to and from a power market and controlling operations of one or more power instruments, the power control program causing the computer to perform:
determining an amount of transmitted/received electric power which is an amount of electric power transmitted to and received from the power market based on a power-market unit price in the power market and information related to an operating situation of the one or more power instruments; and
determining an operation instruction for the one or more power instruments based on the determined amount of transmitted/received electric power.
